(19) United States
(12) Patent Application Publication
(10) Pub. No.: US 2008/0057318 A1
(43) Pub. Date: Mar. 6, 2008

(54) Low density drywall

(76) Inventors: Leonard J. Adzima, Pickerington, OH (US); Paul R. Krumlauf, Thornville, OH (US); David L. Molnar, Newark, OH (US); Kevin J. Spoo, Newark, OH (US)

Correspondence Address: OWENS CORNING, 2790 COLUMBUS ROAD, GRANVILLE, OH, 43023, US

(21) Appl. No.: 11/512,016

(22) Filed: Aug. 29, 2006

(51) Int. Cl. B32B 17/06; B05D 1/36

(52) U.S. Cl. 428/426; 427/407.1

(57) ABSTRACT

A thin drywall board that includes a gel coat, at least one polymer/gypsum layer, and a wet glass fiber layer is provided. The gel coat is formed of a gel coat composition that includes a water dispersible polymer, gypsum, and optionally a crosslinking agent and/or a coupling agent. The polymer/gypsum layer is formed of a matrix composition that includes a water dispersible polymeric resin and gypsum. Components including melamine formaldehyde, a filler material, coupling agents, acetic acid, an accelerator, and/or a hardener may also be added to the matrix composition. The wet glass fiber layer is preferably a glass fiber mat. The combination of the water dispersible polymeric resin and the gypsum in the matrix composition have a synergistic effect that creates a thin drywall board that is water resistant, fire resistant, and has improved mechanical properties. A method of forming the inventive thin drywall boards is also provided.

### TECHNICAL FIELD AND INDUSTRIAL APPLICABILITY OF THE INVENTION

The present invention relates generally to drywall boards, and more particularly, to a lightweight, thin drywall board that is, water resistant, fire resistant, and has improved mechanical properties. The thin drywall board may contain a smooth surface or a textured surface. A method of forming the lightweight, thin drywall board is also provided.

### BACKGROUND OF THE INVENTION

Wall boards formed of a gypsum core sandwiched between facing layers are commonly used in the construction industry as internal walls and ceilings for both residential and commercial buildings. Facing materials advantageously contribute flexibility, nail pull resistance, and impact strength to the materials forming the gypsum core. In addition, the facing material can provide a fairly durable surface and/or other desirable properties (such as a decorative surface) to the gypsum board. The gypsum core typically contains gypsum, optionally some wet chopped glass fibers, water resistant chemicals, binders, accelerants, and low-density fillers. It is known in the art to form gypsum boards by providing a continuous layer of a facing material, such as a fibrous veil, and depositing a gypsum slurry onto the bottom surface of the facing material. A second continuous layer of facing material is then applied to the top surface of the gypsum slurry. The sandwiched gypsum slurry is then sized for thickness and dried to harden the gypsum core and form a gypsum board. Next, the gypsum board may be cut to a predetermined length for end use.

Glass fibers are commonly used in the production of gypsum wall boards to improve the tensile and tear strength of the products. The fibers may be employed in many forms, including individual fibers, strands containing a plurality of fibers, and rovings. These fiber products, in turn, may be used in discrete form or they may be assembled into woven or non-woven fabrics or mats. The fibrous mats may be used as the facing material. For example, glass fibers may be formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected as wet chopped fiber strands.

The wet chopped fibers may then be used in wet-laid processes in which the wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. Next, the slurry containing the fibers is deposited onto a moving screen where a substantial portion of the water is removed to form a web. A binder is then applied, and the resulting mat is dried to remove any remaining water and to cure the binder. The formed non-woven mat is an assembly of dispersed, randomly-oriented individual glass filaments.

It has become commonplace in the industry to utilize such fibrous, wet-laid, non-woven veils as facing materials for gypsum wall boards. Glass fiber facings provide increased dimensional stability in the presence of moisture, biological resistance, and greater physical and mechanical properties than conventional gypsum boards faced with paper or other cellulosic facing materials. However, utilizing such glass fiber facings increases the overall weight of the drywall board, making it more difficult to transport and to attach to the studs of a wall. Attempts have been made to form alternative types of drywall and drywall materials to overcome the shortcomings of current drywall boards. In addition, attempts have been made to lighten the weight of conventional drywall boards while retaining the strength of the conventional gypsum drywall. Some examples are summarized below.

U.S. Pat. No. 6,018,919 to Bodine discloses a wall finishing system in which a sheet material is formed to cover an entire wall. The wall finishing system includes a sheet material that is designed to shrink after the application of the sheet to the wall. The sheet material is manufactured on a release paper that is removed prior to installation, and may be trimmed to fit the wall either prior to or after application. The sheet material may be affixed by an adhesive, double-faced adhesive carpet tape, or staples, which are subsequently covered with trim. An entire wall may be finished using this system, and in some cases, without any seams interrupting the wall plane. The sheet material may be applied over a variety of substrates, including block walls, poured walls, old paneling, and finished or unfinished drywall.

U.S. Pat. Nos. 6,251,979, 6,391,958, and 6,403,688 to Luongo disclose a wallboard composition that includes a combination of synthetic binders selected for their ability to establish a strengthened permanent bond in the final dry state. The synthetic binders are combined with an expanded mineral (e.g., perlite and crushed perlite), organic binding adhesives, drying agents, and hardeners. Calcium sulfate based compounds (a filler material), reinforcement fibers, fire retardants, water repellants, and other water proofing materials may be added to the composition. The wallboard composition is contained within a covering of treated moisture and heat resistant paper materials. The invention utilizes an expanded mineral that physically becomes part of the composite matrix due to the complex formation of binders attaching themselves to the mineral, instead of the mineral acting as a filler. The expanded mineral may be included in the composition anywhere from 13 to 60% of the core composition, thereby enabling a reduction in the amount of gypsum required to make up the core composition. The reduction in the amount of gypsum reduces the weight of the wallboard structure while maintaining its strength. It is asserted that the wallboard composition is up to 50% lighter than current drywall board compositions. In a preferred embodiment, the wallboard formed of the wall board composition includes a covering veneer that is applied to the top ply of the face paper to provide increased strength, moisture resistance, and fire retardancy. A back paper top ply of the face paper may be treated to provide increased flexural strength.

U.S. Pat. No. 6,319,312 to Luongo discloses the general wallboard composition described in U.S. Pat. No. 6,251,797 to Luongo described above. However, in this invention, the binder consists of a mixture of one or more of the following chemicals: a vinyl acetate polymer, liquid plastics such as urethanes and polyurethanes, acrylic polymers, water-based modified aliphatic polymers, water soluble sodium silicate solutions, water-based polyvinyl chloride solutions, and polyvinyl alcohols. Drying agents are used to quickly drive off the moisture. It is asserted that by introducing vinyl acetate, a polyvinyl acetate copolymer, or a vinyl acetate-ethylene copolymer in the composition, the resultant complex molecule is much larger and extends its various branches in all directions. This is a desirable change in the polymeric structure of the molecule to a more highly branched chain polymer having a higher molecular weight that produces an adhesive with increased viscosity, quicker tack, and better fluid properties. Vinyl acetate emulsions were chosen and preferred over acrylic or other petrochemical-based emulsions or liquid plastics. It was also discovered that the addition of small amounts of accelerators or strengthening agents may be added to the final polyvinyl acetate emulsion to increase the strength and final composite set performance.

U.S. Pat. No. 6,340,388 to Luongo discloses the general wallboard composition described in U.S. Pat. No. 6,319,312 Luongo as set forth above. In this invention it was discovered that by varying the furnace input specifications (i.e., temperature from 1000 to 2100° F., rate of i flow, particle sieve size distribution, and internal moisture content of the ore), perlite will expand to an intermediate density with a relatively coarse cell wall structure. Such an expanded perlite was determined to be suitable for use in the present invention. It was disclosed that the preferred composition for the wallboard product includes a starch, boric acid, a vinyl acetate emulsion, perlite, and gypsum. It is asserted that such a composition offers the best results for weight, strength, setting, and bonding of the wallboard core. In a second discovery, it was found that an improved wallboard cover material consists of a manila colored moisture resistant paper face sheet in the range of 40 to 50 pounds with an altered top ply. The manila colored paper includes virgin fibers having a length of 1 inch or greater. It was concluded that the extended length fibers provides an unforeseen and unobvious benefit in providing a much stronger break strength than previously known wallboard structures. In addition, it is asserted that by integrating a virgin pulp top ply with existing recycled wallboard paper plies, increased strength and wet handling characteristics are achieved.

U.S. Patent Publication No. 2001/0001218 A1 to Luongo discloses the general wallboard composition described in U.S. Pat. No. 6,340,388 to Luongo described above. In this application, it was discovered that the combination of starch, boric acid, and vinyl acetate or a water based non-VOC acrylic or polyurethane emulsion is sufficient to bonder the perlite together in forming the gypsum core. It is noted that the construction board of the invention requires an additional binder. Adding another polymer, namely a vinyl acetate emulsion or a water based non-VOC acrylic or polyurethane emulsion to the starch polymer and boric acid enables a crosslinking to occur between the three constituents. On a molecular scale, the polymer chain branches extend in all directions, attaching to the gypsum and perlite, and increasing the overall strength of the board. The crosslinking of the binder with the starch polymer chain is brought about through the use of boron or boric acid.

U.S. Patent Publication No. 2002/0017222 A1 to Luongo discloses the general wallboard composition described in U.S. Patent Publication No. 2001/0001218 A1 to Luongo described above. In this application, it was discovered that certain organic polymers (e.g., aniline formaldehyde resins, melamine formaldehyde resins, urea formaldehyde resins, and urea-melamine formaldehyde resins) may be combined with the polyvinyl acetate or polyvinyl alcohol to provide an alternate binder capable of fully crosslinking with the inorganic materials of the composition to form a strengthened composite core for a construction board. It was also found that the blending of the organic polymers described herein may provide superior adhesion and cohesion properties while enabling an overall lower cost yet fully crosslinking binder.

Despite the existence of gypsum wallboards, there remains a need in the art for an improved gypsum board that is low cost, demonstrates improved water resistance, improved mechanical properties, and is fire resistant.

### SUMMARY OF THE INVENTION

It is an object of the present invention to provide a thin, lightweight drywall board. The thin drywall board may be formed substantially straight or it may be formed to have a desired, pre-determined, non-linear shape. The board is formed of a gel coat, at least one polymer/gypsum layer positioned adjacent to the gel coat, and a glass fiber layer that forms an external surface opposing the gel coat. The polymer gypsum layer is formed of a matrix composition that includes one or more water dispersible polymeric resins and gypsum. The matrix composition may also include a filler material, at least one coupling agent, an organic acid, an accelerator, a hardener, and/or a crosslinking polymer. The gel coat is formed of a gel coat composition that includes at least one water soluble polymer, gypsum, a crosslinking agent and/or accelerator, and optionally, a coupling agent and/or hardener. In a preferred embodiment, the gel coat composition includes melamine formaldehyde as a crosslinking agent. The water dispersible polymer in the matrix composition and the water-soluble polymer in the gel coat composition may be polymeric resin that is at least partially dispersible in water and includes polymeric resins such as acrylic based polymers, polyester emulsions, vinylacetate emulsions, epoxy emulsions, and phenolic based polymers. Preferred polymers come from the family of acrylic latexes. The glass fiber layer is preferably a wet formed mat that includes wet used chopped strand glass fibers (WUCS). The lightweight drywall board may be formed of any number of layers of the glass fiber layer. In a preferred embodiment, the thin drywall board is formed of three layers of the wet glass fiber layer. The gel coat may have a smooth or textured surface. The absence of glass fibers in the gel coat allows for an extremely smooth surface on the drywall board without the need for adding a facing material or other external covering, such as is needed in conventional drywall boards. In addition, the thin drywall board is approximately ⅓ the weight of conventional drywall boards.

The thin, light drywall board may be formed in sizes larger than conventional drywall boards. These large sheets of thin drywall may be cut to provide for doors, windows, and the like, or molded, such as with a curve in them, to conform to the desired shape of a recreational vehicle (RV). In addition, the thin drywall board of the present invention may be attached to the studs of a house, office building, or other desired surface by an adhesive. The strength of the fiberglass mat forming the wet glass layer enables the thin drywall to be attached to a surface with conventional mechanical fasteners such as nails, screws, and/or staples if desired. Further, such a large sized drywall board would permit an entire wall of a house to be drywalled at one time. By not having to piece together shorter, conventional-sized drywall boards, installation of the large sheets of inventive drywall board is easier and faster. In addition, a wall containing a large, thin sheet of inventive drywall would not contain any seams. The thin drywall board has the advantages of being lightweight and having increased strength, increased impact resistance, increased water resistance, the ability to be adhered to a surface with an adhesive, and a class A fire resistance.

It is another object of the present invention to provide a composite board for use as a construction material. The composite board includes a gel coat and multiple stratums or layers formed of polymer/gypsum layers alternating with glass fiber mat layers where a polymer/gypsum layer is positioned next to the gel coat and a glass fiber mat forms the external surface opposing the gel coat. The gel coat is formed from the gel coat composition described above. Similarly, the polymer/gypsum layer is formed from the matrix composition described above. The glass fiber mat is preferably a wet formed glass mat with a weight between about 0.5 lb/100 ft² and about 5.0 lb/100 ft². A composite board according to the present invention may be used as a construction material, such as a structural drywall board, a lumber-like product, or as sheathing in the construction of a house or other building. The composite board provides advantages to conventional drywall boards, lumber, and outdoor sheathing in that it possesses fire resistance and improved strength and impact resistance.

It is yet another object of the present invention to provide a method of forming a composite board for use as a construction material. In forming the composite board, a gel coat composition as described in detail above is applied to the surface of a mold or other releasable surface such as a polyvinyl chloride layer (e.g., a piece of vinyl flooring). The gel coat composition may be applied in any conventional manner, such as, for example, by spraying, rolling, or uniformly metering the gel coat composition onto the mold or other releasable surface. It is desirable that the gel coat be applied evenly to achieve a uniform layer across the thin drywall board. The gel coat composition is then permitted to harden. Typically, the hardening of the gypsum in the gel coat composition occurs in approximately 10 minutes to 30 minutes due to the natural hardening characteristics of the gypsum and, if present in the gel coat composition, the presence of an accelerator or hardener. The gel coat thus formed may have a smooth or a textured surface. For example, the gel coat composition may be applied to a textured mold or to a textured, releasable surface such as vinyl flooring to place a desired texture onto the viewable surface of the thin drywall board. As the gel coat composition hardens, the gel coat composition takes the shape and texture of the mold or other releasable surface. Once the gypsum in the gel coat composition of the gel coat layer has hardened, a polymer/gypsum layer or layers formed of the matrix composition described above are alternatively layered with a wet glass fiber layer or layers on the gel coat. The matrix composition is applied first so that it is positioned on the gel coat. It is not necessary that the crosslinking of the polymer(s) in the gel coat composition be complete when the matrix composition is applied thereto. Once the matrix formulation (polymer/gypsum layer(s)) has reached a sufficient green strength, the composite board is removed from the mold or other releasable surface.

It is an advantage of the present invention that the thin drywall board of the present invention possesses improved physical properties, such as increased strength, stiffness, impact resistance, and water resistance.

It is another advantage of the present invention that the inventive drywall board is Class A fire resistant. A Class A fire rating means that the inventive drywall will not support the spread or propagation of flames.

It is also an advantage of the present invention that the polymeric resin in both the gel coat composition and the matrix composition provide strength, flexibility, toughness, durability, and water resistance to the final product. For example, combinations of melamine formaldehyde resin and acrylic resin produce good quality coatings and give good weather resistance, water resistance, and chemical resistance to the final composite product.

It is yet another advantage of the present invention that gel coat composition easily picks up a design or pattern and may be painted in a single coat if desired.

It is a further advantage of the present invention that the thin drywall board may be formed into large continuous sheets while maintaining strength and impact resistance.

It is another advantage of the present invention that the thin drywall sheets may be adhered to a surface without utilizing mechanical fastening systems such as nails, staples, and screws conventionally utilized in construction processes. However, the thin drywall board also provides the advantage in that it may be utilized with such mechanical fastening systems with a reduction in the occurrence of cracking and other mechanical failures.

It is a feature of the invention that the gel coat composition permits the drywall board to have an extremely smooth surface without the need for adding a facing material or other external covering, such as is needed in conventional drywall boards.

It is another feature of the present invention that the thin drywall boards may be formed with “B” grade mats, which helps to reduce the overall manufacturing costs and reduce the amount of waste generated and introduced into the environment.

It is a further feature of the present invention that the inventive thin drywall board possesses superior water resistance, which would greatly benefit consumers in a flood plain or in a hurricane-prone geographic area.

It is yet another feature of the present invention that that the polymer component permits the inventive drywall board to be manufactured without styrene and the requisite environmental controls.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a lightweight drywall board having three polymer/gypsum layers and three glass fiber mat layers according to at least one exemplary embodiment of the present invention;

FIG. 2 is a schematic illustration of a curved lightweight drywall board having three polymer/gypsum layers and three glass fiber mat layers according to at least one exemplary embodiment of the present invention;

FIG. 3 is a schematic illustration of a conventional drywall board;

FIG. 4 is a schematic illustration of a composite board that includes one polymer/gypsum layer and one glass fiber mat layer according to at least one embodiment of the present invention; and

FIG. 5 is a schematic illustration of a composite board having six polymer/gypsum layers and six glass fiber mat layers according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, “upper”, “lower” and the like are used herein for the purpose of explanation only. It will be understood that when an element is referred to as being “on,” another element, it can be directly on or against the other element or intervening elements may be present. The terms “formulation” and “composition” may be used interchangeably herein. In addition, the terms “polymer” and “polymeric resin” may be used interchangeably. Further, the terms “filler” and “filler material” may be interchangeably used herein.

The present invention relates to a thin, lightweight drywall board that may or may not have a textured surface and a method of making the inventive lightweight drywall board. The drywall board is formed of alternating layers of a matrix formulation and a lightweight fibrous mat positioned on a gel coat. The gel coat may be utilized to pick up a desired design from a mold or other textured surface and becomes a top layer (e.g., viewable surface area) of the thin drywall board. The matrix composition forms a lightweight gypsum board that includes gypsum and a polymeric resin that is at least partially dispersible in water. The combination of the components in the matrix composition have a synergistic effect which creates a thin drywall board that is water resistant, fire resistant, and has improved mechanical properties. Additives such as a density reducing filler material and coupling agents may be added to the matrix composition.

The matrix composition includes one or more polymeric resins that are at least partially dispersible in water, and most preferably, fully dispersible in water. The polymeric resin provides strength, flexibility, toughness, durability, and water resistance to the final product. The polymer may be in the form of a liquid, an emulsion, and/or a powder. The polymeric resin is not particularly limited, so long as it is at least partially water dispersible. The polymer may or may not be self-crosslinking. An additional polymer such as melamine formaldehyde or urea formaldehyde, which acts as crosslinking agent, may be added to assist in the crosslinking reaction, regardless of whether or not the polymer is self-crosslinking. However, it is to be appreciated that if the polymer is not self-crosslinking, a crosslinking agent such as melamine formaldehyde is desirably added to catalyze and assist in the crosslinking reaction.

The crosslinking reaction may occur slowly over time at atmospheric conditions (typically over a period of approximately two weeks). As the crosslinking between the polymers occur and a polymeric network is formed around the gypsum, the molecular weight of the polymer increases. As the molecular weight of the polymer increases, the composition becomes more rigid. The crosslinking reaction may be accelerated upon heating the composition to a moderate temperature, such as to a temperature between about 140° F. to about 160° F. (between about 60° C. to about 71° C.), for a predetermined period of time. It is preferred, however, that the crosslinking reaction be permitted to occur over time at room temperature.

Suitable polymeric resins for use in the composition may include, but are not limited to, acrylic based polymers, polyester emulsions, vinylacetate emulsions, epoxy emulsions, and phenolic based polymers. Specific examples of polymers that may be used in the glass fiber based composition include polyvinyl alcohol (PVA), polyvinyl chloride (PVC), chlorinated polyvinyl chloride (CPVC), polyethylene, polypropylene, polycarbonates, polystyrene, styreneacrylonitrile, acrylonitrile butadiene styrene, acrylic/styrene/acrylonitrile block terpolymer (ASA), polysulfone, polyurethane, polyphenylenesulfide, acetal resins, polyamides, polyaramides, polyimides, polyesters, polyester elastomers, acrylic acid esters, copolymers of ethylene and propylene, copolymers of styrene and butadiene, copolymers of vinylacetate and ethylene, and combinations thereof. In addition, the polymeric resin may be post industrial or consumer grade (regrind).

Preferred polymers come from the family of acrylic latexes. Acrylic monomers used to make acrylic latexes include methyl acrylate, ethyl acrylate, butyl acrylate, and acrylic acid. Combinations of these monomers may be emulsion polymerized to make acrylic resins. These polymers typically contain hydroxyethyl acrylate monomers to impart hydroxyl groups along the polymer chain. These hydroxyl containing polymers are called thermoset acrylics. The acrylic (R—OH) permits crosslinking with other polymers such as melamine formaldehyde or urea formaldehyde. In a preferred embodiment, the crosslinking occurs through both the hydroxyl and ether groups in melamine formaldehyde, and are catalyzed by an acid. Acids and acid producing agents such asp-toluenesulfonic acid and ammonium chloride, which forms hydrochloric acid, are suitable catalysts for the crosslinking reaction. Combinations of melamine formaldehyde resin and acrylic resin produce good quality coatings and give good water resistance and chemical resistance to the drywall board. The use of these polymers allows the drywall board formed by the present invention to be manufactured without styrene and the requisite environmental controls. The polymeric resin(s) may be present in the matrix composition in an amount from about 5.0% to about 35% by weight of the active solids in the composition, preferably from about 15% to about 25% by weight of the active solids.

A second component of the inventive matrix composition is gypsum. Gypsum, also known as calcium sulfate dihydrate (CaSO₄.2H₂O), is a natural mineral derived from the earth. When calcined, three quarters of the water of crystallization is driven off to produce calcium sulfate hemihydrate (CaSO₄.½H₂O). If the calcination is carried out under pressure, an α-form of gypsum is produced. α-gypsum has regular, needle (acicular), or rod shaped particles. On the other hand, if the calcination is conducted at atmospheric pressure, a β-form of gypsum is produced with porous, irregularly-shaped particles. Although the gypsum used in the inventive composition may be α-gypsum, β-gypsum, or a combination thereof, β-gypsum is more preferred due to its lower cost and increased ability to absorb water as compared to α-gypsum. One advantage of gypsum-based materials in general is that they can be shaped, molded, and processed within a short period of time due to gypsum's naturally occurring rapid setting and hardening characteristics. In addition, the gypsum provides a fire resistance property to the drywall board. In the inventive matrix composition, the gypsum absorbs water and goes from a partially hydrated state (naturally occurring state) to a fully hydrated state and hardens. Gypsum may be present in the matrix formulation in an amount from about 35% to about 65% by weight of the active solids in the composition, preferably from about 40% to about 60% by weight of the active solids.

Additional components may be added to the matrix composition to modify properties of the drywall board. For example, low density fillers may be added to reduce the cost, the overall density of the drywall board, and may also be used as an extender. If a denser drywall board is desired, a more dense filler, such as calcium carbonate may be used. Non-limiting examples of suitable fillers that may be used in the matrix formulation include perlite (expanded perlite), calcium carbonate, sand, talc, vermiculite, aluminum trihydrate, recycled polymer materials, microspheres, microbubbles, wood flour, natural fibers, clays, calcium silicate, graphite, kaolin, magnesium oxide, molybdenum disulfide, slate powder, zinc salts, zeolites, calcium sulfate, barium salts, diatomaceous earth, mica, wollastonite, expanded shale, expanded clay, expanded slate, pumice, round scrap glass fibers, flaked glass, nano-particles (such as nano-clays, nano-talcs, and nano-TiO₂), and/or finely-divided materials that react with calcium hydroxide and alkalis to form compounds possessing cementitious properties such as fly ash, coal slag, and silica. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof. Low density fillers are preferred for use in the matrix formulation to reduce the weight of the drywall board. Perlite is a preferred density reducing filler material due to its low cost. In at least one exemplary embodiment, the perlite utilized in the matrix composition has a density from 0.18 g/cc to 0.30 g/cc. Perlite, or another low density filler or fillers, may be present in the matrix formulation in an amount from about 0% to about 10.0% by weight of the active solids in the composition, preferably from about 4.0% to about 8.0% by weight of the active solids in the composition.

The presence of at least one coupling agent in the matrix formulation may also provide added desirable attributes. For example, the presence of a coupling agent helps to bond the organic (polymeric resin) and inorganic (perlite) components of the matrix formulation. In particular, the addition of a coupling agent to the composition increases the bond strength between the perlite and the polymer. Silane coupling-agents are preferred due to their ability to distribute quickly into water. Examples of silane coupling agents that may be used in the matrix composition may be characterized by the functional groups amino, epoxy, vinyl, methacryloxy, ureido, and isocyanato. In preferred embodiments, the silane coupling agents include silanes containing one or more nitrogen atoms that have one or more functional groups such as amine (primary, secondary, tertiary, and quaternary), amino, imino, amido, imido, ureido, or isocyanato. Suitable silane coupling agents include, but are not limited to, aminosilanes, silane esters, vinyl silanes, methacryloxy silanes, epoxy silanes, sulfur silanes, ureido silanes, and isocyanato silanes. When silane coupling agents are used, a small amount of an organic acid (such as acetic acid, formic acid, succinic acid, and/or citric acid) may be added to regulate the pH of the composition, preferably to a pH of about 3 to about 6.5. Acetic acid is the most preferred organic acid for use in the inventive matrix composition.

Specific non-limiting examples of silane coupling agents for use in the inventive composition include γ-aminopropyltriethoxysilane (A-1100), n-trimethoxy-silyl-propyl-ethylene-diamine (A-1120), and γ-glycidoxypropyltrimethoxysilane (A-187). Other non-limiting examples of suitable silane coupling agents are set forth in Table 1. All of the coupling agents identified above and in Table 1 are available commercially from GE Silicones.

TABLE 1

| Silanes | Label |
|---|---|
| Silane Esters | |
| octyltriethoxysilane | A-137 |
| methyltriethoxysilane | A-162 |
| methyltrimethoxysilane | A-163 |
| Vinyl Silanes | |
| vinyltriethoxysilane | A-151 |
| vinyltrimethoxysilane | A-171 |
| vinyl-tris-(2-methoxyethoxy) | A-172 |
| silane | |
| Methacryloxy Silanes | |
| γ-methacryloxypropyl- | A-174 |
| trimethoxysilane | |
| Epoxy Silanes | |
| β-(3,4-epoxycyclohexyl)- | A-186 |
| ethyltrimethoxysilane | |
| Sulfur Silanes | |
| γ- | A-189 |
| mercaptopropyltrimethoxysilane | |
| Amino Silanes | |
| γ-aminopropyltriethoxysilane | A-1101 |
| | A-1102 |
| aminoalkyl silicone | A-1106 |
| γ-aminopropyltrimethoxysilane | A-1110 |
| triaminofunctional silane | A-1130 |
| bis-(γ- | A-1170 |
| trimethoxysilylpropyl)amine | |
| polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

Preferably, the silane coupling agent is an aminosilane or a diaminosilane. The coupling agent may be present in the composition in an amount from about 0% to about 5.0% by weight of the active solids in the composition, preferably from about 0.01% to about 2.0% by weight of the active solids.

An accelerator may be added to the matrix composition to increase the rate at which the gypsum hardens or sets. A preferred accelerator is aluminum sulfate. However, any suitable accelerator identifiable by one skilled in the art may be used, such as, for example, potassium sulfate, terra alba, sodium hexafluorosilicate, sodium chloride, sodium fluoride, sodium sulfate, magnesium sulfate, and magnesium chloride. The accelerator may be present in the matrix formulation in an amount up to about 1.0% by weight of the active solids in the composition, preferably up to about 0.5% by weight of the active solids in the composition. It is to be appreciated that the amount or quantity of accelerator added to the composition may dramatically affect how quickly the gypsum hardens. For example, a large amount of accelerator added to the matrix composition will cause the gypsum to set more quickly than if a smaller amount of accelerator was added to the composition. In other words, a larger amount of accelerator will more quickly increase the speed at which the gypsum hardens compared to a smaller amount of added accelerator.

In addition, a hardener or hardening agent such as ammonium sulfate or ammonium chloride may be added to the composition to increase both the rate of crosslinking and the crosslink density. The hardener may be present in the matrix composition in an amount up to about 1.0% by weight of the active solids in the composition. Additional additives such as dispersants, antifoaming agents, viscosity modifiers, and/or other processing agents may be added to the matrix composition.

To create the matrix composition that may be utilized to form the lightweight drywall board, the dry components of the composition, such as, for example, melamine formaldehyde, gypsum, and filler (e.g., perlite) may be dry blended in a container to form a dry mixture. Wet components of the composition, such as water, the emulsion polymer, and coupling agent(s) are stirred in a second container until they are blended. The dry mixture may be slowly added to the wet components in the second container with stirring until all the dry mixture is added and the resulting composition is well blended. The amount of water in the matrix composition may vary dramatically based the desired mechanical properties of the drywall board, but water is typically present in the matrix composition in an amount of approximately ⅓ of the amount of gypsum present. It is to be appreciated, however, that the amounts of one or more of the components of the matrix composition may vary outside the ranges recited above and the amounts of the components of the matrix composition are ultimately dependent upon the intended use of the drywall board, such as, for example, if the drywall board is intended for use as an internal drywall board, an external sheathing, a large, continuous sheet of drywall board (e.g., 8 feet high by 40 feet in length), or a lumber board. Not wishing to be bound by theory, it is believed that the mechanical properties may be optimized for these various uses by the chemistry of the matrix composition.

The composition of the gel coat may be formed of at least one water soluble polymer, gypsum, one or more crosslinking agents (each of which is described in detail above with respect to the matrix composition), and water. Additionally, a coupling agent such as is described above may be added to the gel coat composition to assist in releasing the gel coat from a mold or textured surface. Further, the gel coat composition may optionally include an accelerator and/or a hardening agent. The gel coat composition preferably contains melamine formaldehyde as a crosslinking agent to assist in crosslinking the polymer(s) in the gel coat composition. The water soluble polymer, gypsum, crosslinking agent, and coupling agent(s) in the gel coat composition may or may not be the same compound as is utilized in the matrix composition.

The water soluble polymer may be present in the gel coat composition in an amount from about 10% to about 30% by weight of the active solids in the gel coat composition, preferably in an amount from about 15% to about 25% by weight of the active solids. The gypsum may be present in the gel coat composition in an amount from about 40% to about 70% by weight of the active solids in the gel coat composition, preferably in an amount from about 50% to about 60% by weight of the active solids. The crosslinking agent may be present in the gel coat composition in an amount from 0% to about 15% by weight of the active solids in the gel coat composition, preferably in an amount from about 4.5% to about 6.5% by weight of the active solids. An accelerator may be present in the gel coat composition in an amount from 0% to about 0.1% by weight of the active solids in the gel coat composition, preferably in an amount from about 0.01 to 0.1% by weight of the active solids. In addition, a hardening agent may be present in the gel coat composition in an amount from 0% to about 0.1% by weight of the active solids in the gel coat composition, preferably in an amount from about 0.01 to 0.1% by weight of the active solids. The coupling agent may be present in an amount up to about 1.0% by weight of the active solids of the gel coat composition. The gel coat composition may be mixed in a manner consistent with that of the matrix composition in which the dry components (e.g., melamine formaldehyde and gypsum) are separately mixed and are added to a mixture of the wet components (e.g., water and coupling agent(s)) in a separate container until the wet and dry components of the gel coat composition are well blended.

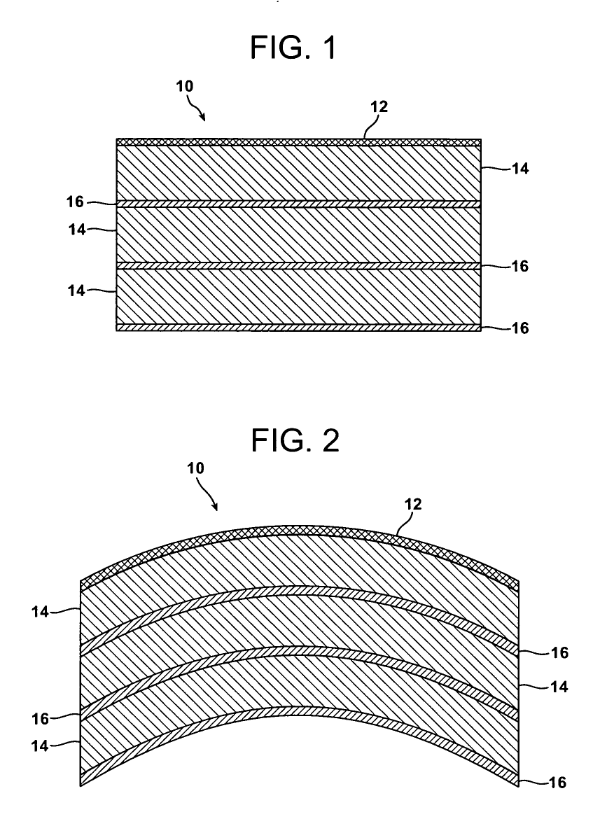

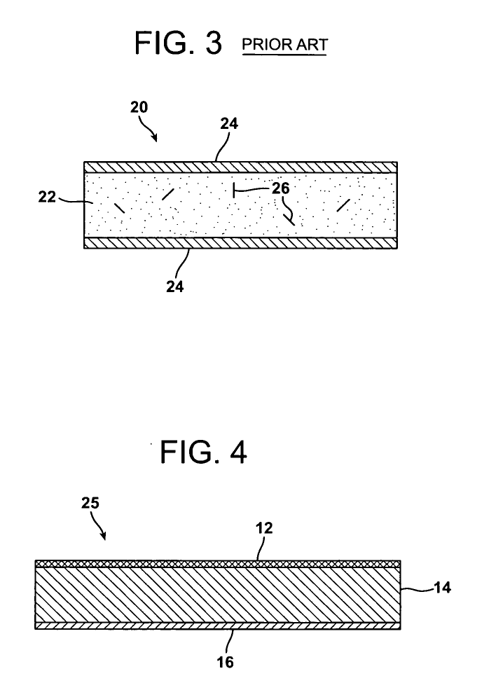

In one exemplary embodiment of the invention, a lightweight, multilayered drywall board is made by an open mold, hand lay-up process. A lightweight drywall board 10 that includes a dry gel coat and alternating layers of the matrix composition described above and glass mat layers is illustrated in FIG. 1. It is to be appreciated that the thin drywall board 10 may be formed substantially straight, as shown in FIG. 1, or it may be formed to have a desired, non-linear shape. As used herein, the term “substantially straight” is meant to indicate that the drywall board is straight or nearly straight. For example, a curved mold may be used to produce a curved drywall board 10 such as is depicted in FIG. 2. In making the lightweight drywall board 10 depicted in FIGS. 1, 2, and 4, a gel coat composition according to the present invention is applied to the surface of a mold or other releasable surface such as a polyvinyl chloride (PVC) layer. The gel coat composition may be applied in any conventional manner, such as, for example, spraying, rolling, or uniformly metering the gel coat composition onto the mold or releasable surface. It is desirable that the gel coat composition be applied evenly to achieve a uniform layer or as nearly a uniform layer as possible across the finished drywall board. The gel coat composition is then permitted to harden and form a gel coat 12. Typically, the hardening of the gypsum in the gel coat composition occurs in approximately 10 to 30 minutes due to the natural hardening characteristics of the gypsum (e.g., the fast hydration reaction of the gypsum with the water), and, if present in the gel coat composition, the fast hardening of the gypsum is also a result of the action of the accelerator or hardening agent. The gel coat 12 thus formed may have a smooth or a textured surface. For example, the gel coat composition may be applied to a textured mold or to a textured, releasable surface such as vinyl flooring to place a desired texture onto the viewable surface of the thin drywall board. As it hardens, the gel coat composition takes the shape and texture of the mold or other releasable surface. The absence of glass fibers in the gel coat layer 12 allows for an extremely smooth surface on the drywall board without the need for adding a facing material or other external covering, such as is needed in a conventional drywall board such as is illustrated in FIG. 3. In addition, the gel coat provides for a surface that is easily paintable in a single coat of paint.

Once the gypsum in the gel coat composition of the gel coat 12 has hardened, a layer or layers formed of the matrix composition are alternately layered with a glass fiber layer or layers 16 on the gel coat 12, with the matrix composition being applied on the gel coat 12. The matrix formulation forms a polymer/gypsum layer 14 in the drywall board 10. It is to be noted that it is not necessary that the crosslinking of the polymer(s) in the gel coat composition be complete when the matrix composition is applied thereto. In addition, it is desirable that the matrix formulation be in a liquid or semi-liquid state so that the matrix formulation can at least partially saturate the wet glass fiber layer 16. Once the matrix formulation (i.e., the polymer/gypsum layer(s)) has reached a sufficient green strength, the drywall board is removed from the mold or other releasable surface. It is not required that the crosslinking reaction between the polymers be complete before the drywall board is removed from the mold or releasable surface. In fact, the crosslinking reaction between the polymers in the matrix composition typically occurs for a period of time after the drywall board has been removed from the mold or releasable surface.

In a preferred embodiment, three layers of the glass fiber layer 16 are utilized to form the textured, thin drywall board. One of the glass fiber layers 16 is positioned on an external surface of the thin, drywall board. The glass fiber layer 16 preferably contains wet glass fibers and is desirably in the form of a wet formed mat that includes wet used chopped strand glass fibers (WUCS). Preferred mats for use as the wet glass layer 16 include WUCS-based shingle mats available from Owens Corning (Toledo, Ohio, USA) with weights between about 0.5 lb/100 ft² and about 5.0 lb/100 ft², preferably between about 1.5 lb/100 ft² and about 2.5 lb/100 ft², more preferably less than about 2 lb/100 ft², and most preferably between about 1.75 lb/100 ft² and about 1.95 lb/100 ft². According to the present invention, it is not necessary to utilize “A” grade fiberglass mats. “B” grade mats, or mats with a non-structural defect of some kind (e.g., a visual defect) which would cause the mat to be otherwise be disposed of, may be utilized in forming the thin drywall board, without any reduction in strength or other mechanical/physical properties. Utilizing “B” grade mats in the drywall boards of the present invention helps to reduce the overall manufacturing costs and reduces the amount of waste generated and introduced into the environment. Although the glass fiber layer 16 is described herein with reference to a wet formed glass mat, a preferred embodiment, the glass fiber layer 16 may be formed of mats composed of other types of fibers, such as, but not limited to, synthetic fibers such as polypropylene or polyethylene, natural fibers, a continuous strand mat, or a chopped strand glass mat that is not formed of WUCS fibers. The physical characteristics of the drywall board 10 are at least partially dependent upon the type of mat chosen to form layer 16, and it is to be appreciated that not all mats will provide the same physical characteristics of the glass fiber mats.

The drywall board 10 illustrated in FIG. 1 may be utilized in the same manner and have the same size as conventional drywall (i.e., 4 feet wide by 8 feet long), but the inventive thin drywall board has a thickness of approximately ⅓ the size of conventional drywall and is much lighter and stronger. In at least one exemplary embodiment of the present invention, the thin drywall board 10 is formed in sizes much larger than conventional drywall boards, such as, for example, continuous sheets that are 8 feet wide and 40 feet long. It is to be appreciated that the 8 feet by 40 feet size of the inventive drywall board is but one example of any number of sizes of thin drywall that may be made according to the present invention. It is also to be appreciated that any number of other sizes of the inventive thin drywall may be formed that are larger than the conventional 4 feet by 8 feet size. Such large sheets of the inventive thin drywall board 10 may be advantageously utilized in the manufacture of pre-fabricated homes or in the construction of a recreational vehicle (RV). The large sheets of thin drywall may be cut to provide for doors, windows, and the like, or molded, such as with a curve in them, to conform to the desired shape of the RV.

Unlike conventional drywall, the thin drywall board 10 of the present invention may be attached to the studs of a house, office building, or other desired surface by an adhesive. By attaching the thin drywall board 10 to a designated surface by an adhesive, both time and cost can be saved. It is possible to affix the inventive thin drywall board 10 to a surface with conventional mechanical fasteners such as nails, screws, and/or staples. The strength of the fiberglass mat forming the wet glass layer 16 provides sufficient strength to hold the mechanical fastener and securely affix the inventive drywall board to the designated surface. However, this is not a preferred method of attachment due to the fact that the nail holes or screw holes would have to be filled in and smoothed over to provide a finished, paintable surface, unlike when an adhesive is used to attach the thin drywall board 10 to a surface. Further, in an embodiment where the drywall board 10 is formed in a large size (e.g., 8 feet by 40 feet), the large size of the thin drywall board 10 would permit, for example, an entire wall of a house to be drywalled at one time. By not having to piece together shorter, conventional drywall boards, installation of the large sheets of inventive drywall board is easier and faster. In addition, a wall containing a large, thin sheet of inventive drywall 10 would not contain any seams. The seams connecting the pieces of drywall would be present at the corners of the room, and not positioned intermittently along the wall as with conventional drywall boards.

Other embodiments of the present invention include composite boards 25 such as is illustrated in FIG. 4 that have a gel coat 12, one polymer/gypsum layer 14 formed of the matrix formulation positioned on the gel coat 12, and a single wet glass layer 16 positioned on the polymer/gypsum layer 14. As with the thin layer drywall board 10 described above, the gel coat 12 on the composite board 25 may have a smooth or a desired textured surface. The composite board 25 may be used as a veneer. For example, the composite board 25 may be utilized, such as, for example, as a facing layer in conventional drywall or on a paneled wall in a basement.

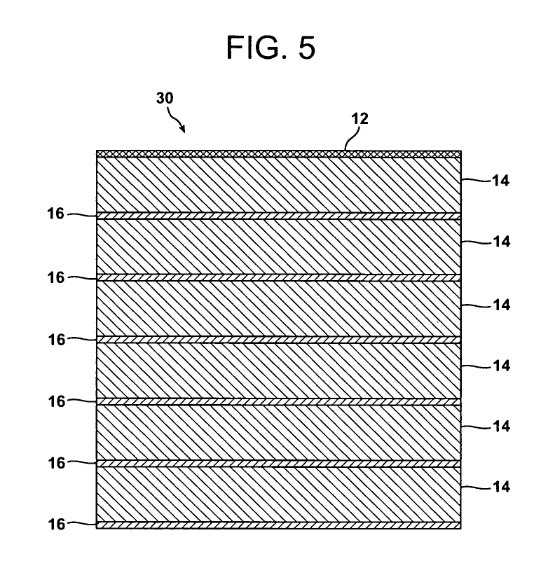

In another alternate embodiment, a composite board may be formed utilizing more than three layers of the wet glass fiber layer 16. For example, a composite board may be formed of multiple stratum (layers) formed of the polymer/gypsum layer 14 alternating with the wet glass fiber layer 16. As shown in the example depicted in FIG. 5, a composite board 30 that has six layers of the glass fiber layer 16 (e.g., glass fiber mat) may be formed. As with the embodiments described above, the composite board 30 has a gel coat 12 formed of the gel coat composition with alternating layers of the gypsum/polymer layer 14 formed of the matrix composition and the wet glass fiber layers 16. Such a composite board 30 according to the present invention may be used as a construction material, such as, for example, for sheathing in the construction of a house or other building. The composite board 30 provides advantages to conventional sheathing in that it possesses weather resistance, fire resistance, improved strength and impact resistance, and it is lightweight and easy to install. In a further alternate embodiment, it is possible to form a lumber-like material having structural properties if enough glass fiber layers 16 are provided.

The thin lightweight drywall board 10 may be used as replacements for conventional gypsum boards such as the conventional drywall board 20 depicted in FIG. 3. In conventional drywall boards 20, a gypsum core 22 is positioned between two facing layers 24. The facing layer 24 may be selected from materials that provide desired physical, mechanical and/or aesthetic properties. Examples of materials that may be used as the facing layers 24 include a glass fiber scrim, a veil or fabric, woven or non-woven materials, and paper or other cellulosic items. Facing layers 24 advantageously contribute flexibility, nail pull resistance, and impact strength to the materials forming the gypsum core 22. In addition, the facing layers 24 can provide a fairly durable surface and/or other desirable properties such as a decorative surface to the conventional drywall board 20. The gypsum core 22 typically contains gypsum, optionally some wet chopped glass fibers 26, water resistant chemicals, binders, accelerants, and low-density fillers. It is to be noted, however, that the glass fibers 26 are present in the gypsum core 22 in an amount much less (e.g., up to approximately 0.2% by weight glass fibers) than the amount of glass fibers utilized in the wet glass fiber layer 16 of the present invention.

Unlike conventional drywall boards 20, the thin drywall board 10 has the advantages of being lightweight and having increased strength, increased impact resistance, increased water resistance, and it may be adhered to a surface by an adhesive. Additionally, the thin drywall board 10 can achieve these advantageous properties at lower weights than conventional drywall. The thin drywall board 10 may be produced either in-line (e.g., in a continuous manner), or off-line. Preferably, the manufacturing of the thin drywall board 10 is conducted in-line to increase manufacturing efficiency.

One advantage of the gel coat composition and the matrix composition of the present invention is they form a thin drywall board that is Class A fire resistant. For example, the gypsum provides fire resistance to the inventive drywall board. A Class A fire rating means that a thin drywall board formed from the inventive gel coat and matrix compositions will not support the spread or propagation of flames.

In addition, the matrix formulation of the present invention imparts improved physical properties, such as improved strength, stiffness, and increased impact resistance to the finished lightweight drywall board.

It is also advantageous that the polymeric resin provides strength, flexibility, toughness, durability, and water resistance to the inventive drywall board. In particular, combinations of melamine formaldehyde resin and acrylic resin produce good quality coatings and give good weather resistance, water resistance, and chemical resistance to the final drywall board or composite board as described herein.

Having generally described this invention, a further understanding can be obtained by reference to the specific example illustrated below which is provided for purposes of illustration only and is not intended to be all inclusive or limiting unless otherwise specified.

Example: Thin Drywall Board

Small samples of thin drywall boards were prepared by forming (1) a gel coat composition formed of α-gypsum, a polyacrylic latex emulsion, an epoxy silane coupling agent, and melamine formaldehyde and (2) a matrix formulation formed of α-gypsum, a polyacrylic latex emulsion, a silane coupling agent, melamine formaldehyde, and an accelerator (ammonium sulfate) in accordance with the present invention. The gel coat composition and the matrix composition were each individually formed by dry mixing the dry components (α-gypsum, melamine formaldehyde, and ammonium sulfate (only in the instance of the matrix composition)) were dry mixed in a container. The wet components (the polyacrylic latex emulsion and coupling agent) were mixed in a mixing container. The dry components were then added gradually to the mixing container until the wet and dry components were fully mixed. The resulting gel coat composition and matrix composition were used to manufacture 12″×12″ samples of thin drywall boards that included between 1 to 5 layers of Owens Corning's 1.95 lb/ft² shingle mat. The gel coat composition was applied to the mold and permitted to harden prior to the application of the matrix composition. Alternating layers of glass mat and matrix composition were then applied, with a glass mat forming the external surface of the drywall board opposing the gel coat. After sufficient time had passed, the samples of thin drywall were removed from the mold. The physical properties of the various drywall samples are shown in Table 1.

TABLE 1

| | Sample of | Drywall | | | | Drywall |
|---|---|---|---|---|---|---|
| | drywall | board | | | | board |
| | board | wt. | Mat wt | % glass | Thickness | wt. |
| | # of plies | (grams) | (grams) | (wt) | (in) | (oz/ft²) |
| Panel 1 | 1 | 213 | 11 | 5.2 | 0.06 | 7.5 |
| Panel 2 | 2 | 331 | 20.3 | 6.1 | 0.09 | 11.7 |
| Panel 3 | 3 | 500 | 29.5 | 5.9 | 0.13 | 17.7 |
| Panel 4 | 5 | 740 | 49.5 | 6.7 | 0.21 | 26.1 |
| Panel 5 | 1 | 448 | 10.5 | 2.3 | 0.28 | 15.8 |

Two-ply and three-ply inventive thin drywall samples were tested for various mechanical properties, including tensile strength (ASTM D638), tensile modulus (ASTM D638), and Izod impact strength (unnotched) (ASTM D4812). These two- and three-ply thin drywall samples were also tested for water absorption following the testing procedures set forth in ASTM D570. The results of the mechanical testing are set forth in Table 2.

TABLE 2

| | | | | | 3 ply |
|---|---|---|---|---|---|
| | | | | 2 ply | glass mat |
| | | | ⅝ inch | glass mat | thin |
| Test | | | conventional | thin drywall | drywall |
| Method | Property | Units | drywall | sample | sample |
| | Thickness | Inches | 0.625 | 0.090 | 0.130 |
| ASTM | Tensile | psi | 302 | 2,389 | 3,897 |
| D638 | Strength | | | | |
| ASTM | Tensile | ksi | 4.30 | 1,288 | 1,312 |
| D638 | Modulus | | | | |
| ASTM | Izod Impact | in-lb | 0.483 | 3.076 | 4.257 |
| D4812 | (unnotched) | | | | |
| ASTM | Water | % | 44.6 | 1.6 | 1.5 |
| D570 | Absorption | | | | |

It can be concluded from Table 2 that the two- and three-ply thin drywall samples possessed a much larger tensile strength than the tested conventional drywall. In addition, the glass reinforcement in drywall samples caused a vast increase in the impact strengths of the inventive drywall board over the tested conventional drywall. Further, as the amount of plies of the glass mats increased from two to three plies, the tensile strengths substantially increased. It is believed that as more glass mats are added to the inventive drywall board in a layered fashion with the matrix composition, the impact resistance of the inventive drywall board will continue to increase. Additionally, it can be seen from Table 2 that both the two- and three-ply drywall board samples absorbed significantly less water than the conventional drywall. This decrease in water absorption is significant in that the inventive drywall boards may be used in areas prone to receiving a lot of water, such as in a flood plain or a hurricane zone without ruining the inventive drywall board. Also, it is to be noted that both the all of the tested inventive drywall board samples were thinner than the conventional drywall (Panel 5). One advantage provided by the thinness of the inventive drywall board is that more product may be transported at one time, thereby saving in transportation costs. Thus, it can be concluded from Table 2 that the inventive drywall boards have increased impact strength, improved tensile strength, and decreased water absorption in products and are thinner than conventional drywall.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A lightweight, thin drywall board comprising:
a gel coat, said gel coat forming an exterior, viewable surface;
a first polymer/gypsum layer positioned on said gel coat, said polymer/gypsum layer being formed of a matrix composition including:
one or more water dispersible polymeric resins; and
gypsum; and
a first glass fiber mat layer positioned on said first polymer/gypsum layer to form an external surface opposing said gel coat.

2. The thin drywall board of claim 1, wherein a reinforcement layer is positioned between said first polymer/gypsum layer and said first glass fiber mat layer, said reinforcement layer including a second glass fiber mat layer located next to said first polymer/gypsum layer and a second polymer/gypsum layer located next to said first glass fiber mat layer.

3. The thin drywall board of claim 2, wherein a second reinforcement layer including a third glass fiber mat layer and a third polymer/gypsum layer is positioned adjacent to said first reinforcement layer such that said glass fiber mat layers and said polymer/gypsum layers alternate.

4. The thin drywall board of claim 3, wherein said gel coat has a surface selected from the group consisting of a smooth surface and a textured surface.

5. The thin drywall board of claim 3, wherein said gel coat is formed of a gel coat composition including:
at least one water soluble polymer;
gypsum; and
a crosslinking polymer or an accelerating agent.

6. The thin drywall board of claim 5, wherein said gel coat composition includes melamine formaldehyde as a crosslinking polymer.

7. The thin drywall board of claim 3, wherein said matrix composition further comprises at least one member selected from the group consisting of a filler material, at least one coupling agent, an organic acid, an accelerator, a hardener and a crosslinking polymer.

8. The thin drywall board of claim 3, wherein said drywall board is formed as a continuous sheet that is larger in size than conventional drywall boards.

9. The thin drywall board of claim 5, wherein said gel coat composition further comprises at least one member selected from the group consisting of a coupling agent and a hardening agent.

10. A composite board for use as a construction material comprising:
a gel coat, said gel coat forming an exterior, viewable surface; and
multiple stratums formed of polymer/gypsum layers alternating with glass fiber mat layers such that a first polymer/gypsum layer is positioned next to said gel coat and a last glass fiber mat forms an external surface opposing said gel coat.

11. The composite board of claim 8, wherein said polymer/gypsum layer is formed of a matrix composition including:
one or more water dispersible polymeric resins; and
gypsum; and

12. The composite board of claim 9, wherein said matrix composition further comprises at least one member selected from the group consisting of a filler material, at least one coupling agent, an organic acid, an accelerator, a hardener and a crosslinking polymer.

13. The composite board of claim 9, wherein said gel coat is formed of a gel coat composition including:
at least one water soluble polymer;
gypsum; and
a crosslinking polymer or an accelerating agent.

14. The composite board of claim 11, wherein said gel coat composition further comprises at least one member selected from the group consisting of a coupling agent and a hardening agent.

15. The composite board of claim 9, wherein composite board includes three or more of said glass fiber mat layers and forms a structural drywall board, sheathing, or a lumber board.

16. The composite board of claim 13, wherein said composite board contains three of said polymer/gypsum layers and three of said glass fiber mat layers to form a drywall board that is equal to or greater than the size of conventional drywall boards.

17. A method of forming a composite board for use as a construction material comprising the steps of:
placing a gel coat composition on a releasable surface, said releasable surface being smooth or textured;
permitting said gel coat composition to harden and form a gel coat; and
alternately layering a polymer/gypsum layer and a glass fiber mat layer on said gel coat to form a composite board; and
wherein one of said polymer/gypsum layers is positioned adjacent to said gel coat and one of said glass fiber mat layers forms an external opposing surface to said gel coat.

18. The method of claim 15, wherein said placing step includes an application method selected from the group consisting of spraying, rolling and uniformly metering said gel coat composition onto said releasable surface.

19. The method of claim 15, wherein said gypsum/polymer layers are formed of a matrix composition comprising:
one or more water dispersible polymeric resins; and
gypsum.

20. The method of claim 17, further comprising the step of removing the composite board from said releasable surface.

21. The method of claim 17, wherein said gel coat composition comprises:
at least one water soluble polymer;
gypsum; and
a crosslinking polymer or an accelerating agent.

22. The method of claim 19, wherein said gel coat composition further comprises at least one member selected from the group consisting of a coupling agent and a hardening agent.
